(19) United States
(12) Patent Application Publication
(10) Pub. No.: US 2009/0245717 A1
(43) Pub. Date: Oct. 1, 2009

(54) SYSTEM AND METHOD FOR MEASURING STATOR WEDGE TIGHTNESS

(75) Inventors: Alan Michael Iversen, Clifton Park, NY (US); Sameh Ramadan Salem, Rexford, NY (US); Joseph Alan Worden, Clifton Park, NY (US); Anthony Rigosu, Albany, NY (US); Ronald Irving Longwell, Ballston Lake, NY (US); Adrian Matthew Breitenstein, JR., Delanson, NY (US)

Correspondence Address: CANTOR COLBURN, LLP, 20 Church Street, 22nd Floor, Hartford, CT, 06103, US

(73) Assignee: GENERAL ELECTRIC COMPANY, Schenectady, NY (US)

(21) Appl. No.: 12/056,687

(22) Filed: Mar. 27, 2008

(51) Int. Cl. G01B 11/16; G02B 6/00

(52) U.S. Cl. 385/12; 356/32

(57) ABSTRACT

Disclosed is a system for measuring stator wedge tightness in a stator core of an electric machine. The system includes at least one sensor located along at least one component disposed in a stator slot of the stator core. The at least one sensor is located and configured to measure strain in the component. The system further includes a data acquisition system operably coupled to the at least one sensor. A method for measuring stator wedge tightness in a stator core of an electric machine includes arranging at least one sensor along at least one component of the stator core, the at least one sensor being located and configured to measure strain in the component, and interrogating the at least one sensor utilizing a data acquisition system.

### BACKGROUND

The subject invention relates to electric machines. More particularly, the subject invention relates to the monitoring of stator wedge tightness in electric machines.

Stator slots of rotating electric machines including, for example, turbine-generators, hydro-generators, motors, and wind-generators, typically include various components and support structure disposed therein. These components, which include stator wedges, undergo long-term shrinkage due to thermal aging and compressive creep. The stator wedges, which are normally fixed in position, may loosen over time and may result in damage to the stator winding of the electrical machine. Currently, various methods are used to evaluate stator wedge tightness including ball peen hammers, hardness testers, and acoustic methods. These current methods, however, require that the electrical machine be off-line to perform the necessary measurement. Additionally, the current methods tend to be operator sensitive and subject to operator interpretation of the results. Further, the electrical machine must be at least partially disassembled to perform the measurement which increases machine downtime.

### BRIEF DESCRIPTION OF THE INVENTION

The present invention solves the aforementioned problems by providing a system for measuring stator wedge tightness in a stator core of an electric machine. The system includes at least one sensor located along at least one component of the stator core. The at least one sensor is located and configured to measure strain in the component. The system further includes a data acquisition system operably coupled to the at least one sensor.

A method for measuring stator wedge tightness in a stator core of an electric machine includes arranging at least one sensor along at least one component of the stator core, the at least one sensor being located and configured to measure strain in the component, and interrogating the at least one sensor utilizing a data acquisition system.

These and other advantages and features will become more apparent from the following description taken in conjunction with the drawings.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is a perspective view of the components in a stator core slot;

FIG. 2 is an exploded view detail of the components of FIG. 1 including an optical fiber sensor; and

FIG. 3 is a schematic view of an optical fiber sensor and a data acquisition system.

The detailed description explains embodiments of the invention, together with advantages and features, by way of example with reference to the drawings.

### DETAILED DESCRIPTION OF THE INVENTION

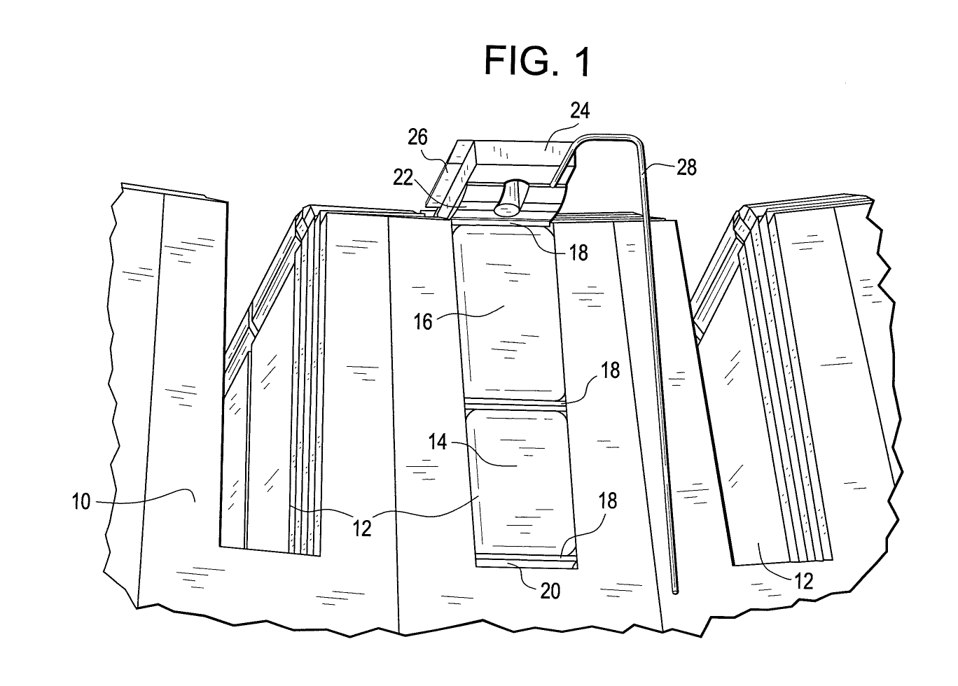

Referring to FIG. 1, a stator core 10 includes a plurality of stator slots 12. An outer stator bar 14 and inner stator bar 16 are disposed in one or more of the plurality of stator slots 12. At least one slot filler 18 is located between the outer stator bar 14 and a slot base 20 of the stator slot 12, and at least one slot filler 18 is additionally located between the outer stator bar 14 and the inner stator bar 16. A ripple spring 22 is located radially inboard of the inner stator bar 16 in the stator slot 22 with an additional one or more slot fillers 18 disposed between the ripple spring 22 and the inner stator bar 16. A slide wedge 24 is disposed radially inboard of the ripple spring 22 and an end wedge 26 is disposed radially inboard of the ripple spring 22 in the stator slot 12.

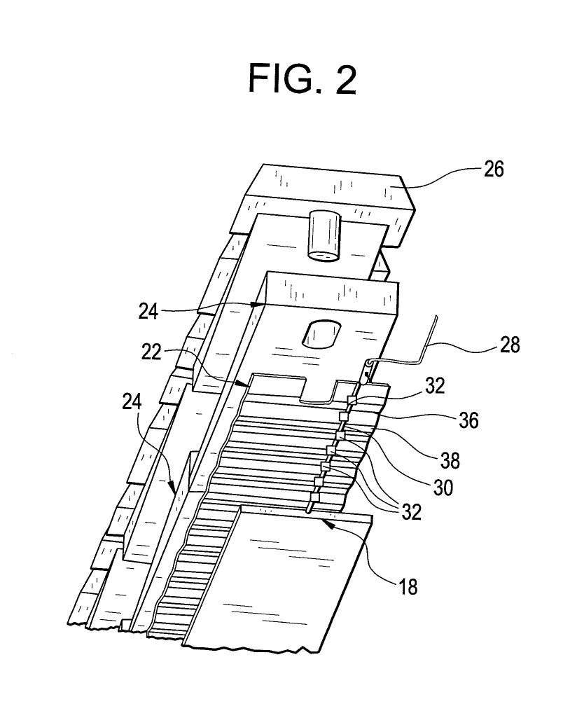

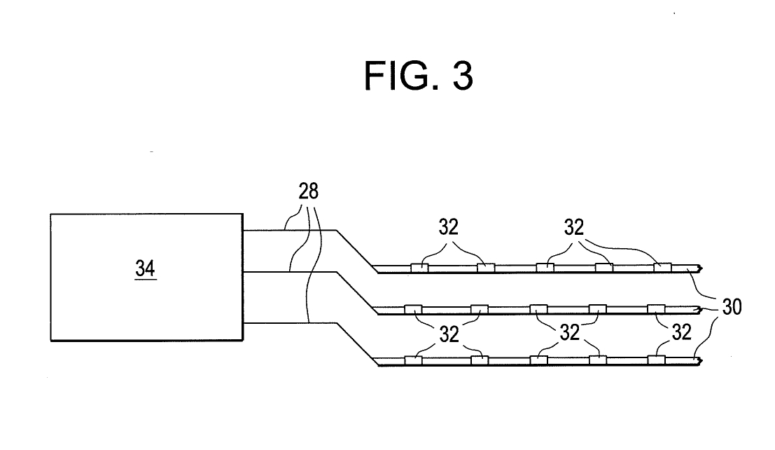

As shown in FIG. 2, stator slot components include at least one optical fiber sensor 28 which may be, for example, bonded to the ripple spring 22 using epoxy or other adhesive means or embedded into the ripple spring 22 during its manufacture. In some embodiments, the optical fiber sensor 28 comprises a single fiber optic cable 30 with a plurality of sensors 32, for example, Fiber Bragg grating sensors, distributed along the fiber optic cable 30. As shown in FIG. 3, one or more optical fiber sensors 28 are operably coupled to a data acquisition system 34, which includes a scanning laser (not shown). The optical fiber sensor 28 and data acquisition system 34 may be obtained, for example, from Luna Innovations which provides such under its marketing name, “Distributed Sensing System”. The data acquisition system 34 is configured to transmit a signal to each sensor 32 along the fiber optic cable 30. The sensors 32 reflect a signal back to the data acquisition system 34 which is indicative of the amount of strain in the ripple spring 22. In some embodiments, the reflected signal from each sensor 32 is modulated by a unique frequency such that filtering applied in the data acquisition system 34 allows for retrieval of the signal of each discreet sensor 32.

Referring now to FIGS. 2 and 3, during assembly of the components into the stator slot 12, the ripple spring 22 is compressed to a nearly flat state as opposing slide wedges 24 and end wedges 26 are located in place. As the slide wedges 24 and end wedges 26 are installed, a radial deflection flattens the ripple spring 22, and establishes the wedge tightness. The flattening of the ripple spring 22 results in alternating tension and compression in the optical fiber sensor 28 depending on whether a particular sensor 32 is disposed in a convex or concave portion of the ripple spring 22. The data acquisition system 34 will measure a positive strain or negative strain depending on whether the particular sensor 32 being interrogated is in tension or compression. The data acquisition system 34 interrogates the sensors 32 at a predetermined spatial interval, which in some embodiments is about lcm, resulting in spatially distributed strain data. The interval should be chosen such that at least one sensor 32 is located at a peak 36 or a valley 38 of the ripple spring 22 in order to provide measurements at areas of maximum strain in the ripple spring 22. As the components in the stator slot 12 shrink and/or progressively creep over operation of the electric machine, the ripple spring 22 will decompress, resulting in a decrease in the magnitude of measured strain. The decrease in measured strain reflects a loss of wedge pressure or tightness. Because the measured strain is directly related to wedge tightness, the need to perform a re-wedging or re-tightening operation is indicated when the measured strain reaches a threshold amount. Utilization of the optical fiber sensor 28 allows measurements of wedge tightness to not only be obtained when the electric machine is off-line, but also allows measurements to be taken while the electric machine is in operation.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A system for measuring stator wedge tightness in a stator core of an electric machine comprising:
at least one sensor affixed to at least one component of the stator core, the at least one sensor disposed and configured to measure strain in the component; and
a data acquisition system operably coupled to the at least one sensor.

2. The system of claim 1 wherein the at least one sensor comprises at least one optical fiber.

3. The system of claim 1 wherein the at least one sensor is disposed along at least one optical fiber.

4. The system of claim 3 wherein the at least one optical fiber is bonded to the at least one component with adhesive.

5. The system of claim 4 wherein the at least one optical fiber is embedded in the at least one component.

6. The system of claim 1 wherein the at least one component comprises a ripple spring.

7. The system of claim 1 wherein at least one sensor is a Fiber Bragg grating sensor.

8. The system of claim 1 wherein the data acquisition system is configured to interrogate a sensor of the at least one sensor at a predetermined spatial interval.

9. The system of claim 1 wherein one or more of the at least one sensors are disposed at a maximum strain point of the at least one component.

10. A method for measuring stator wedge tightness in a stator core of an electric machine comprising:
arranging at least one sensor along at least one component of the stator core, the at least one sensor affixed to the at least one component and configured to measure strain in the at least one component;
interrogating the at least one sensor utilizing a data acquisition system; and
correlating a strain measured by the at least one sensor to stator wedge tightness.

11. The method of claim 10 further comprising relating a decrease in a magnitude of measured strain to a decrease in stator wedge tightness.

12. The method of claim 11 further comprising comparing the decrease in stator wedge tightness to a threshold value.

13. The method of claim 10 wherein the at least one component comprises at least one ripple spring.

14. The method of claim 10 wherein the method is performed during operation of the electric machine.
